(19) United States
(12) Patent Application Publication
(10) Pub. No.: US 2026/0285625 A1
(43) Pub. Date: Sep. 24, 2026

(54) METHOD AND TRANSFER STATION FOR AUTOMATED LOADING OF A HOLDER WITH PIECES OF BAGGAGE POSITIONED ONE NEXT TO AND ONE ABOVE THE OTHER

(71) Applicant: Vanderlande Industries B.V., VEGHEL (NL)

(72) Inventors: Peter Eliza HOEFKENS, VEGHEL (NL); Pim Mathieu Theodorus VAN LOON, VEGHEL (NL)

(21) Appl. No.: 19/473,816

(22) PCT Filed: Apr. 8, 2024
(86) PCT No.: PCT/NL2024/050180

§ 371 Date: Oct. 9, 2025

(30) Foreign Application Priority Data
Apr. 12, 2023 (NL) 2034546

(51) Int. Cl. B65G 61/00; B25J 9/16

(52) U.S. Cl. CPC B65G 61/00; B25J 9/1679; B25J 9/1697; B65G 2201/0264

(57) ABSTRACT

A method for automated loading of a holder with pieces of baggage positioned one next to and one above the other, comprising the steps of-placing pieces of baggage to be loaded in a first group of pieces of baggage with a surrounding wall that, at least to a large extent, is composed of relatively hard material, or in a second group of pieces of baggage with a surrounding wall that, at least to a large extent, is composed of relatively soft material,-supplying pieces of baggage to be loaded to the at least one transfer position belonging to a transfer station, and -with the aid of at least one manipulator belonging to the transfer station, moving pieces of baggage to be loaded from a transfer position of the at least one transfer position to a holder. In this case, a control unit of the transfer station, on the basis of the placements of the pieces of baggage to be loaded, controls the at least one manipulator in such a way that, in the holder, at least a bottom layer, a top layer and at least one intermediate layer situated between the bottom layer and the top layer are formed, wherein each layer consists of a number of pieces of baggage that have each been placed in the same group, and wherein an intermediate layer has both thereabove and therebelow a layer of which the pieces of baggage have been placed in the other group in relation to the pieces of baggage of the respective intermediate layer.

The present invention concerns automated loading of a holder with pieces of baggage positioned one next to and one above the other. In the context of the present invention, such a holder can typically be formed by a loading space of a cart or by a container, such as of the unit load device (ULD) type. In use, such ULD containers are loaded with pieces of baggage outside an aircraft and are placed in their entirety in the baggage hold of an aircraft. A holder can furthermore be formed by the loading space of baggage carts. Such baggage carts can be both driven self-propelled vehicles and trailers. Pieces of baggage are driven by way of such carts to an aircraft, where the pieces of baggage are moved from the loading space of the carts into the baggage hold of an aircraft, optionally with the aid of mechanical aids, such as an upwardly inclined and mobile transport belt

It is known that loading of the aforementioned holders is heavy work, and, partly for that reason, it is also known that such work is carried out in an automated manner. This is described for example in the European patent application EP 1070664A2 . In this publication, it is described that relatively heavy and hard pieces of baggage are placed in the holder first and that lighter and soft pieces of baggage are placed thereon. In practice, it has been found that fully automated loading of holders with pieces of baggage is less efficient than traditional loading of pieces of baggage by hand in the sense that, on average, a holder can be loaded with more pieces of baggage manually than in an automated manner. Moreover, it has been found that, in practice, manual loading of a significant proportion of the number of pieces of baggage in the holder is still often opted for, and that it is regularly necessary to interrupt the automated loading of pieces of baggage in order to manually perform corrective actions at the stack of pieces of baggage because the stack proves to be unstable or, at least, is different than what the control unit provides for.

The present invention aims to offer a solution or at least an improvement to the aforementioned drawbacks and, to this end, according to a first aspect of the invention, provides a method as claimed in claim 1. In this case, the invention is based on the understanding that the above-described known stacking strategy can lead to an unstable stack, and that the stability of the stack, on average, is improved if use is made of at least one layer with relatively soft pieces of baggage between layers of relatively hard pieces of baggage, which in practice are often relatively heavy too. In claim 1, it is described inter alia that an intermediate layer has both thereabove and therebelow a layer of which the pieces of baggage have been placed in the other group in relation to the pieces of baggage of the respective intermediate layer. In order to avoid any misunderstandings, it is noted that this description relates both to the situation in which the respective intermediate layer makes direct contact with the stated layer situated thereabove that has been placed in the other group and/or the stated layer situated therebelow, and to the situation in which the respective intermediate layer makes direct contact with neither the stated layer situated thereabove that has been placed in the other group nor the stated layer situated therebelow. A relatively soft layer ensures that a layer with relatively hard pieces of baggage that is stacked thereon is supported in a more stable manner, there will be a reduced tendency of in particular the hard pieces of baggage to shift, and the available space is used more efficiently. Relatively hard pieces of baggage from the first group are also referred to by the term hard bags, hard-case baggage or hard-shell baggage. Such hard bags, of which the material comprises for example polycarbonate (PC), polypropylene (PP), acrylonitrile butadiene styrene (ABS) or an aluminum alloy, will deform to a relatively little extent under load and have the tendency, if stacked one on the other, to shift from one another. The soft pieces of baggage, also referred to by the term soft bags, are typically composed of a material such as nylon, polyester or (artificial) leather and are by their nature relatively flexible and will consequently deform to a greater extent under load than hard bags. Moreover, the material of soft bags is generally less smooth that that of hard bags. The invention concerns automated loading with which it is not excluded that loading of a limited proportion of the number of pieces of baggage with which a holder is loaded, for example only the last 20%, is carried out manually, or that occasionally it will still be necessary to interrupt the automated loading for manual intervention. Overall, due to the invention, a relatively large amount of the loading can take place in an automated manner, whereby there will be less of a need for personnel to be physically burdened for this purpose. Moreover, the available space of the holder can be used more efficiently. The placement of individual pieces of baggage in the first group or in the second group may take place shortly before the loading of the holder but also shortly after the piece of baggage has been checked in by a passenger and for example be coupled with a baggage label which is fastened to the piece of baggage and which can be read in an automated manner, for example by a barcode scanner.

The stability of the stack can benefit if the control unit controls the at least one manipulator in such a way that an intermediate layer has directly thereabove and/or directly therebelow a layer of which the pieces of baggage have been placed in the other group in relation to the pieces of baggage of the respective intermediate layer.

In a further embodiment, the control unit controls the at least one manipulator in such a way that the pieces of baggage belonging to the bottom layer have been placed in the first group and the pieces of baggage belonging to the intermediate layer situated directly thereon have been placed in the second group. The bottom layer comes to lie on the base of the holder.

Again from the point of view of increasing the stability of the stack of layers, it may furthermore be advantageous if the control unit controls the at least one manipulator in such a way that an intermediate layer has thereabove and/or therebelow a layer of which the pieces of baggage have been placed in the same group as the pieces of baggage of the respective intermediate layer.

According to a further embodiment, the control unit controls the at least one manipulator in such a way that a further layer situated between an intermediate layer and the top layer comprises pieces of baggage from the other group in relation to both those of the respective intermediate layer and those of the top layer, and/or in such a way that a further layer situated between an intermediate layer and the bottom layer comprises pieces of baggage from the other group in relation to both those of the respective intermediate layer and those of the bottom layer. The further layer is thus by definition also an intermediate layer, albeit a different intermediate layer than that referred to in the previous sentence.

The stability of the stack can be further increased if the control unit controls the at least one manipulator in such a way that the combined weight of the pieces of baggage belonging to the top half of the number of layers is less than the combined weight of the pieces of baggage of the pieces of baggage belonging to the bottom half of the number of layers, and/or if the control unit controls the at least one manipulator in such a way that the average volume of the pieces of baggage belonging to the top half of the number of layers is less than the average volume of the pieces of baggage of the pieces of baggage belonging to the bottom half of the number of layers. Insofar as the number of layers is odd, the middle, by definition intermediate, layer may be excluded from consideration. The weight and the volume of individual pieces of baggage may be determined shortly before the loading of the holder but also shortly after the piece of baggage has been checked in by a passenger and for example be coupled with a baggage label which is fastened to the piece of baggage and which can be read in an automated manner, for example by a barcode scanner. Information on the weight and the volume of individual pieces of baggage is communicated to the control unit after the determination thereof.

The stability of the stack of layers in the holder can be further increased if the method comprises the step of determining dimensions of the pieces of baggage to be loaded and of selecting by way of the control unit, partly on the basis of the determined dimensions, pieces of baggage which are going to form a layer in the holder. Therefore, the pieces of baggage of a layer can be selected by the control unit in such a way that the respective heights thereof, that is to say the vertical dimension of the pieces of baggage belonging to a layer, are at least substantially equal, so that the surface formed by the top sides of the respective pieces of baggage in the layer is straight and horizontal, whereby a layer which follows can lie in a stable manner thereon.

In a practical embodiment, the pieces of baggage to be loaded are supplied to one of two or more, preferably of four or more, transfer positions, and the at least one manipulator moves the pieces of baggage to be loaded to the holder from different transfer positions. The supply to the transfer positions of pieces of baggage to be loaded may be realized on the basis of properties of the pieces of baggage, such as placement in the first group or in the second group, weight, dimensions and/or volume of the respective piece of baggage. It can thus be achieved that, at all times or at least relatively often, there is a suitable piece of baggage directly available, in order for the holder to be simultaneously loaded with the aid of the manipulator.

The indicated high degree of availability of suitable pieces of baggage can be accomplished in particular if the transfer positions are provided at ends of an associated conveyor, wherein the distance between successive pieces of baggage on the respective conveyors is at most 10 cm. The pieces of luggage to be loaded are then relatively close to one another while being supplied to a transfer position, whereby a transfer station which is used for carrying out the method may be designed to be relatively compact.

In one embodiment, the holder is the loading space of a baggage cart or a container, such as a container of the unit load device (ULD) type.

Although it is possible to allow the placement in the first and second groups to take place on the basis of human observation, it is also possible to allow this selection to take place in an automated manner. To this end, the method may comprise the step of observing pieces of baggage to be loaded using a camera, and of placing the pieces of baggage to be loaded in the first group or in the second group on the basis of the observations by the control unit. With the aid of the camera, the type of the material of a piece of baggage, or at least of the surrounding wall thereof, can be determined. The shape of a piece of baggage, too, can, optionally in part, be a determining factor for the determination of whether a piece of baggage should be placed in the first or second group, for example on the basis of the contours of a piece of baggage and/or on the basis of any wheels and/or handles of the piece of baggage. If the contours of the piece of baggage and/or the shaping of the handles are tight, this is at least an indication that the respective piece of baggage should be placed in the first group.

According to a second aspect, the invention provides a transfer station for automated loading of a holder with pieces of baggage positioned one next to and one above the other as claimed in claim 13. A person skilled in the art will understand the advantages associated with such a transfer station on the basis of the above description of the method according to the invention.

In possible embodiments, each conveyor of the at least one conveyor comprises a belt conveyor and/or a camera, and/or the at least one manipulator comprises a six-axis robot.

The invention will be discussed in more detail below on the basis of the following figures:

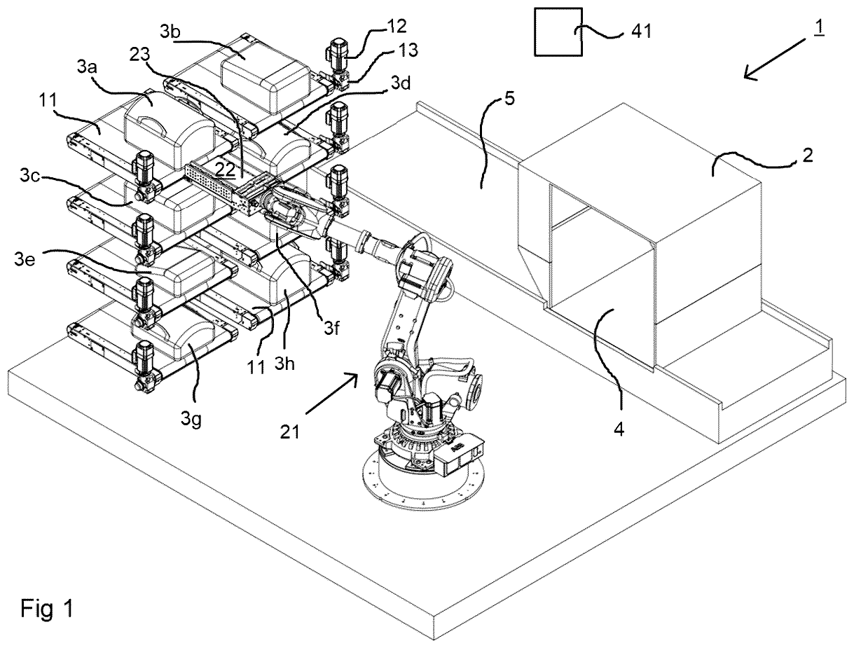

FIG. 1 shows a transfer station according to the invention in an isometric view;

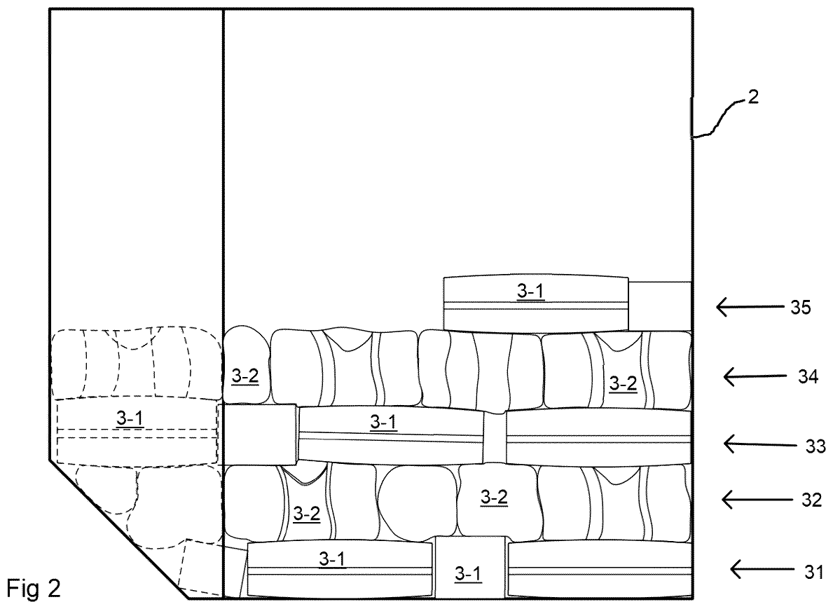

FIG. 2 shows a ULD container during loading thereof according to the invention in a vertical front view.

FIG. 1 shows a transfer station 1 for automated loading of a ULD container 2 with pieces of baggage 3. The transfer station 1 comprises a schematically illustrated electronic control unit 41. The ULD container 2 rests on a belt conveyor 4 which is controlled by the control unit 41 during operation and by way of which a container 2 to be loaded can be supplied to the transfer station 2 and discharged again from the transfer station 1. FIG. 1 shows eight such pieces of baggage 3a to 3f, denoted by reference numeral 3 below and above insofar as the distinction is unimportant, each of which is situated at a transfer position. Each transfer position relates to the downstream end of a short belt conveyor 11, each of which for example has a length of 100 cm. Each belt conveyor 11 is provided with a drive motor 12 which is controlled by the control unit 41 during operation and which, via a right-angled transmission 13, drives that deflector roller of the belt conveyor 11 which is situated furthest downstream. Each drive motor 12 is controlled by the control unit 41 during operation. The upstream ends of all of the belt conveyors 11 are adjoined by supply conveyors (not shown in any more detail). Preferably, the pieces of baggage 3 on the supply conveyors are situated at a distance of at most 10 cm from one another. Pieces of baggage to be loaded into the container 2 can be supplied to one of the belt conveyors 11 in a different manner, too, such as by way of an automated guided vehicle (AGV), a lift or a shuttle, for example from a store where pieces of baggage are temporarily stored.

The transfer station 1 further comprises a manipulator which is designed as a standing six-axis robot 21. The robot 21 is provided at the free end of the outermost arm thereof with a transfer tool designed as a gripper 22, as is known to a person skilled in the art and as is described for example in the European patent application EP 1174374 A1 and in the research publication RD 690031. The transfer tool 22 comprises a belt conveyor 23. During operation, the robot 21 positions the belt of the belt conveyor 23 opposite a belt conveyor 11 at the transfer position where a piece of baggage 3 to be loaded is situated. Through simultaneous driving of the belt conveyor 23 and the belt conveyor 11, the respective piece of baggage 3 is transferred from the transfer position to the belt conveyor 23. Subsequently, the robot 21 moves the transfer tool 22 via the opening 4 to a position in the container 2, whereupon the robot 21 performs a retraction movement while at the same time the belt conveyor is driven in such a way that the respective piece of baggage 3, in spatial terms, initially remains at the same position and, as soon as the belt conveyor has moved away completely below the piece of baggage 3, drops into the container 2 at a desired position.

During the loading of the container 2 with pieces of baggage 3, layers are formed in the container 2, which layers are stacked one on top of the other, as can be seen in FIG. 2. In FIG. 2, the container 2 has already been loaded with four full layers 31, 32, 33 and 34, and the fifth layer 35 has been partly loaded. For the purpose of loading the container 2, each of the pieces of baggage 3, prior to the loading thereof, was placed in a group, specifically in a first group of pieces of baggage 3-1 with a surrounding wall that, at least to a large extent, is composed of relatively hard material, or in a second group of pieces of baggage 3-2 with a surrounding wall that, at least to a large extent, is composed of relatively soft material. Pieces of baggage 3-1 placed in a first group will generally exhibit stiffer and smoother behavior, or be stiffer and smoother, than pieces of baggage 3-2 from the second group. The placement of the pieces of baggage 3 in one of the two groups took place prior to the loading of the holder 2, and the respective placement was stored in a memory of the control unit 41. The determining process can take place on the basis of human observation but can also take place in an automated manner, for example with the aid of a camera and possibly using image recognition. The observations by the camera provide information on the type of the material of the surrounding wall of a piece of baggage, for example whether or not it is reflective or whether or not it is smooth, and moreover it is also the case that the shaping of pieces of baggage 3 can be a relatively reliable indication of whether a piece of baggage 3 has to be placed in the first group or in the second group.

Furthermore, with the aid of a camera or with the aid of other sensors (not shown in any more detail but known per se to a person skilled in the art), such as a light curtain, it is possible to obtain information on the dimensions of the pieces of baggage, which information is also stored in the memory of the control unit 41 and is used by the control unit 41 to give each of the pieces of baggage 3 in a particular layer 31-35 a comparable height, whereby a layer lying on the respective layer can be supported in a stable manner with a relatively low risk of undesired movement of the respective pieces of baggage 3 after these have been moved onto the layer situated therebelow with the aid of the robot 21.

In FIG. 1, the pieces of baggage 3b, 3c, 3e and 3f represent relatively hard pieces of baggage, which have been placed in the first group, and the pieces of baggage 3a, 3d, 3g and 3h represent relatively soft pieces of baggage, such as for example holdalls or rucksacks, which have been placed in the second group. Furthermore, the pieces of baggage 3a, 3b, 3c, 3f and 3h have a relatively great height and the pieces of baggage 3d, 3e and 3g have a relatively small height. The control unit 41 ensures that a piece of baggage 3 is available at at least one of the eight transfer positions at any moment, such as that necessary at that moment to be able to load the container 2.

The loading of the container 2, or in fact in particular the robot 21, is controlled by the control unit 41 in such a way that the layers 31 to 35, in an alternating manner, either exclusively comprise pieces of baggage 3-1 from the first group or exclusively comprise pieces of baggage 3-2 from the second group, wherein moreover the respective pieces of baggage 3 in the same row have at least substantially the same height. This prevents there being two layers lying one on top of the other that each contain pieces of baggage 3-1 from the first group. The risk of such pieces of baggage inadvertently sliding away is thus limited. The invention does not exclude the positioning in the container 2 of a limited portion of the pieces of baggage 3 with which the container 2, or generally a holder, is not loaded by the robot 21. The loading of in particular the last pieces of baggage 3 with which a holder is loaded may also take place manually.

In an alternative embodiment, it may also be the case that, in the stack, use is made between layers with pieces of baggage 3-1 from the first group not just of one intermediate layer with pieces of baggage 3-2 from the second group but of two or more such intermediate layers, which are situated one on top of the other.

Apart from the placement of the individual pieces of baggage 3 in the first group or in the second group, the control unit 41 may, for the purpose of loading the container 2 with pieces of baggage 3, also take into account the volume and/or the weight of the individual pieces of baggage 3, specifically such that the total weight of the pieces of baggage 3 of the bottom half of the layers is greater than the total weight of the pieces of baggage 3 of the top half of the layers, and/or such that the average volume of the pieces of baggage 3 belonging to the top half of the layers is smaller than the average volume of the pieces of baggage of the pieces of baggage 3 belonging to the bottom half of the number of layers, so as to thus obtain an (even) more stable stack.

1. A method for automated loading of a holder with pieces of baggage positioned one next to and one above the other, comprising:
placing pieces of baggage to be loaded in a first group of pieces of baggage with a surrounding wall that, at least to a large extent, is composed of relatively hard material, or in a second group of pieces of baggage with a surrounding wall that, at least to a large extent, is composed of relatively soft material,
supplying pieces of baggage to be loaded to at least one transfer position belonging to a transfer station,
with the aid of at least one manipulator belonging to the transfer station, moving pieces of baggage to be loaded from a transfer position of the at least one transfer position to a holder,
wherein a control unit of the transfer station, on the basis of the placements of the pieces of baggage to be loaded, controls the at least one manipulator in such a way that, in the holder, at least a bottom layer, a top layer and at least one intermediate layer situated between the bottom layer and the top layer are formed, wherein each layer consists of a number of pieces of baggage that have each been placed in the same group, and wherein an intermediate layer has both thereabove and therebelow a layer of which the pieces of baggage have been placed in the other group in relation to the pieces of baggage of the respective intermediate layer.

2. The method according to claim 1, wherein the control unit controls the at least one manipulator in such a way that an intermediate layer has directly thereabove and/or directly therebelow a layer of which the pieces of baggage have been placed in the other group in relation to the pieces of baggage of the respective intermediate layer.

3. The method according to claim 1, wherein the control unit controls the at least one manipulator in such a way that the pieces of baggage belonging to the bottom layer have been placed in the first group and the pieces of baggage belonging to the intermediate layer situated directly thereon have been placed in the second group.

4. The method according to claim 1, wherein the control unit controls the at least one manipulator in such a way that an intermediate layer has thereabove and/or therebelow a layer of which the pieces of baggage have been placed in the same group as the pieces of baggage of the respective intermediate layer.

5. The method according to claim 1, wherein the control unit controls the at least one manipulator in such a way that a further layer situated between an intermediate layer and the top layer comprises pieces of baggage from the other group in relation to both those of the respective intermediate layer and those of the top layer, and/or in such a way that a further layer situated between an intermediate layer and the bottom layer comprises pieces of baggage from the other group in relation to both those of the respective intermediate layer and those of the bottom layer.

6. The method according to claim 1, wherein the control unit controls the at least one manipulator in such a way that the combined weight of the pieces of baggage belonging to the top half of the number of layers is less than the combined weight of the pieces of baggage of the pieces of baggage belonging to the bottom half of the number of layers.

7. The method according to claim 1, wherein the control unit controls the at least one manipulator in such a way that the average volume of the pieces of baggage belonging to the top half of the number of layers is less than the average volume of the pieces of baggage of the pieces of baggage belonging to the bottom half of the number of layers.

8. The method according to claim 1, comprising the step of determining dimensions of the pieces of baggage to be loaded and of selecting by way of the control unit, partly on the basis of the determined dimensions, pieces of baggage which are going to form a layer in the holder.

9. The method according to claim 1, wherein the pieces of baggage to be loaded are supplied to one of two or more, transfer positions, and wherein the at least one manipulator moves the pieces of baggage to be loaded to the holder from different transfer positions.

10. The method according toas claim 9, wherein the transfer positions are provided at ends of an associated conveyor, and wherein the distance between successive pieces of baggage on the respective conveyors is at most 10 cm.

11. The method according to claim 1, wherein the holder is the loading space of a baggage cart or a container, such as a container of the unit load device (ULD) type.

12. The method according to claim 1, comprising the step of observing pieces of baggage to be loaded using a camera, and of placing the pieces of baggage to be loaded in the first group or in the second group on the basis of the observations by the control unit.

13. A transfer station for automated loading of a holder with pieces of baggage positioned one next to and one above the other, comprising
at least one transfer position for making pieces of baggage to be loaded available there, wherein each transfer position is situated at an end of a conveyor,
at least one manipulator for moving pieces of baggage to be loaded from a transfer position of the at least one transfer position to a holder,
a control unit which is configured for controlling the at least one manipulator, on the basis of placements of pieces of baggage to be loaded in a first group of pieces of baggage with a surrounding wall that, at least to a large extent, is composed of relatively hard material, or in a second group of pieces of baggage with a surrounding wall that, at least to a large extent, is composed of relatively soft material, in such a way that, in the holder, a bottom layer, a top layer and at least one intermediate layer situated between the bottom layer and the top layer are formed, wherein each layer consists of a number of pieces of baggage that have each been placed in the same group, and wherein an intermediate layer has both thereabove and therebelow a layer of which the pieces of baggage have been placed in the other group in relation to the pieces of baggage of the respective intermediate layer.

14. The transfer station according to claim 13, further comprising at least one conveyor for transporting the holder, the at least one conveyor including a belt conveyor.

15. The transfer station according to claim 13, wherein the at least one manipulator comprises a six-axis robot.

16. The transfer station according to in claim 13, comprising a camera for observing pieces of baggage to be loaded, wherein the control unit is configured to place the pieces of baggage to be loaded, on the basis of the observations, in the first group or in the second group.
